(19) United States
(12) Patent Application Publication
(10) Pub. No.: US 2017/0205058 A1
(43) Pub. Date: Jul. 20, 2017

(54) MULTI-PURPOSE LIGHT EMITTING DIODE LAMP WITH ARTICULATING HEAD AND CLIP

(71) Applicant: Marche International LLC, Lawrence, KS (US)

(72) Inventor: Christopher J. Ostrander, Lawrence, KS (US)

(21) Appl. No.: 15/473,912

(22) Filed: Mar. 30, 2017

Related U.S. Application Data
(63) Continuation-in-part of application No. 15/136,033, filed on Apr. 22, 2016.
Application No. 15/136,033 is a continuation-in-part of application No. 14/884,579, filed on Oct. 15, 2015.
(60) Provisional application No. 62/315,477, filed on Mar. 30, 2016.
(60) Provisional application No. 62/150,963, filed on Apr. 22, 2015.
(60) Provisional application No. 62/064,332, filed on Oct. 15, 2014.

(51) Int. Cl. F21V 21/088; F21V 17/10; F21V 23/06; F21L 4/02; F21V 21/096; F21V 33/00; F21V 17/02; F21V 23/04

(52) U.S. Cl. CPC F21V 21/0885; F21V 17/02; F21V 17/107; F21V 23/0414; F21L 4/02; F21V 21/0965; F21V 23/0407; F21V 33/0008; F21V 23/06; F21Y 2115/10

(57) ABSTRACT

A lamp including an articulating head element containing several light-emitting diodes (LEDs). The lights have several modes of lighting, which are selectable via a power switch or other switch. The different modes include solid lights in a directed cone, solid lights in all directions, blinking lights, off, or a combination thereof. The LEDs are contained within a head portion which is connected to a base by a hinge or a pin element. The head portion may be tilted up away from the base between zero degrees and 90 degrees. A preferred embodiment would allow the arm to stop at any angle, but it should at least stop perpendicular to the base at 90 degrees. A clip allows the lamp to be connected to an article of clothing or a metallic surface via a magnet within the clip.

### CROSS REFERENCE TO RELATED APPLICATION

This application claims priority in U.S. Provisional Patent Application No. 62/315,477, filed Mar. 30, 2016, and is a continuation-in-part of U.S. patent application Ser. No. 15/136,033, filed Apr. 22, 2016, now U.S. Publication No. 2016/0238224, which is a continuation-in-part of U.S. application Ser. No. 14/884,579, filed Oct. 15, 2015, now U.S. Publication No. 2016/0109105, which claims priority in U.S. Provisional Patent Application No. 62/064,332, filed Oct. 15, 2014, all of which are incorporated herein by reference.

### BACKGROUND OF THE INVENTION

1. Field of the Invention

The present invention relates generally to a light-emitting diode (LED) lamp, and more specifically to a multi-purpose, multi-function road lamp with articulating head and clip.

2. Description of the Related Art

Typical chemical road lamps are dangerous, unpredictable, and finite. These lamps burn hot and pose fire risks. They degrade over time and may not be functional in a time of need. Once their fuel burns down, they are useless.

Existing electronic road lights and road lamps, including those using light-emitting diodes (LEDs) have been used in recent years. Typically, these devices are designed merely to replace the chemical road lamps of years past. However, in doing so these LED lamps do not improve upon the prior art other than to exchange the light source from the fire of a road lamp to the light emitted from the LED.

Other LED lamps include head lamps or flashlights. However, these typically have limited functionality based upon how they are constructed, and are generally not useful outside of their intended functions. Head lamps, for example, are not very fashionable or useful outside of general utility settings.

What is needed is an LED road lamp which embraces the obvious advantages of the LED and incorporates those advantages into a lamp device which has multiple useful features.

Heretofore there has not been available a multi-purpose LED lamp with the advantages and features of the present invention.

### BRIEF SUMMARY OF THE INVENTION

The present invention generally provides a lamp including an articulating head element containing several light-emitting diodes (LEDs). The lights have several modes of lighting, which are selectable via a power switch or other switch. The different modes include solid lights in a directed cone, solid lights in all directions, blinking lights, off, or a combination thereof.

The LEDs are contained within a head portion which is connected to a base by a hinge or a pin element. The head portion may be tilted up away from the base if the base is placed on a flat surface, such that the panel is some angle between zero degrees and 90 degrees away from the base. A preferred embodiment would allow the arm to stop at any angle, but it should at least stop perpendicular to the base at 90 degrees. This allows the LED to be viewed from passersby while the base provides a solid support preventing the lamp from tipping.

A clip allows the lamp to be connected to an external body, such as a shirt pocket, the bill of a cap, or some other article of clothing. Magnets within the clip also allow the lamp to be placed against a metallic surface, such as the inside of a automobile hood or on the roof of an automobile.

The LEDs may be powered by replaceable batteries, such as standard AA or AAA Lithium Ion batteries, or it may contain a semi-permanent rechargeable battery and recharge port. A preferred embodiment includes a USB male-charging element covered by a cap having a lanyard hole.

### BRIEF DESCRIPTION OF THE DRAWINGS

The drawings constitute a part of this specification and include exemplary embodiments of the present invention illustrating various objects and features thereof.

FIG. 1 it a three-dimensional view of a preferred embodiment of the present invention in a disassembled, articulated position.

FIG. 2 is a three-dimensional view of an embodiment thereof shown in an assembled, un-articulated position.

FIG. 3 is a right side elevational view thereof.

FIG. 4 is a rear elevational view thereof.

FIG. 5 is front elevational view thereof.

FIG. 6 is a top plan view thereof.

FIG. 7 is a bottom plan view thereof.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Preferred Embodiment Light-Emitting Diode (LED) Lamp 2

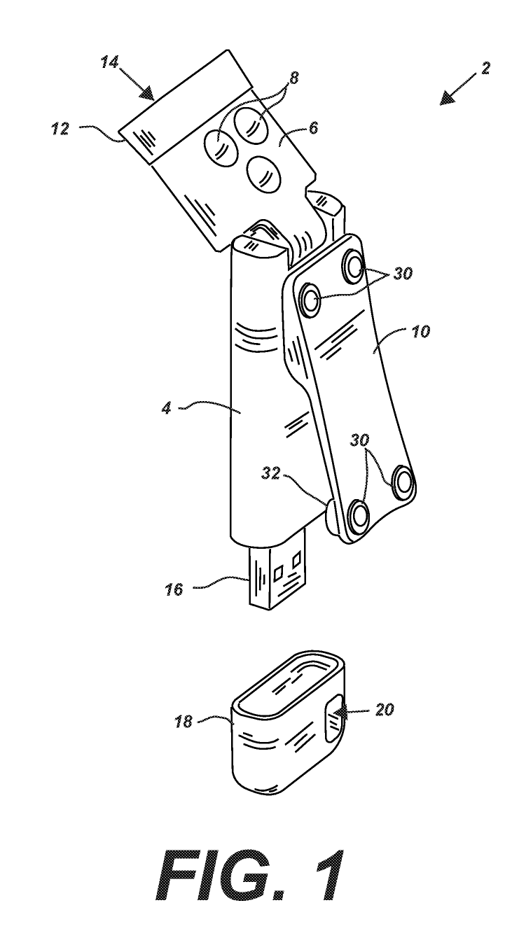

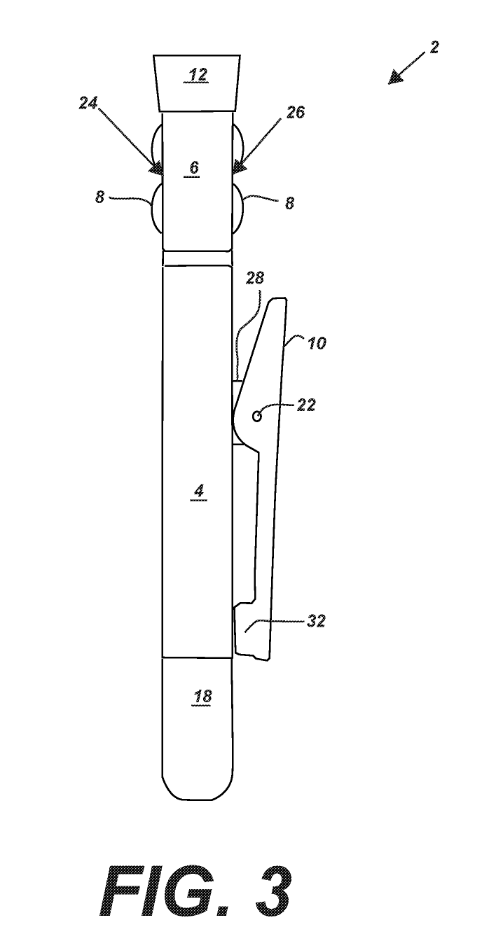

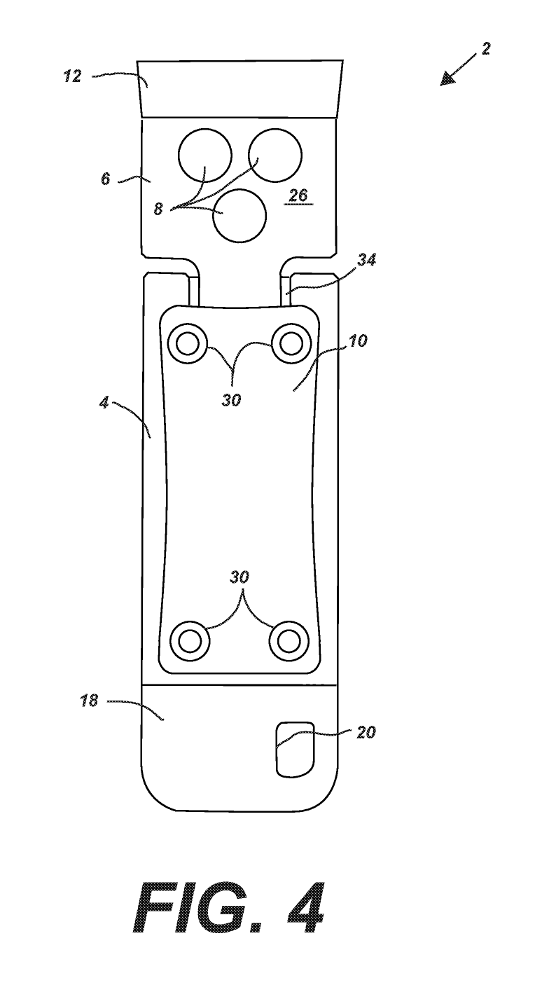

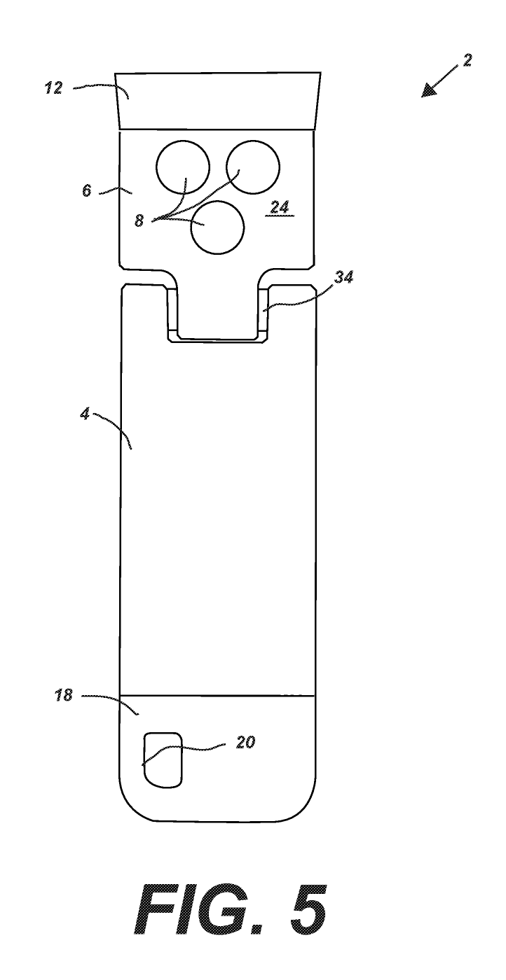

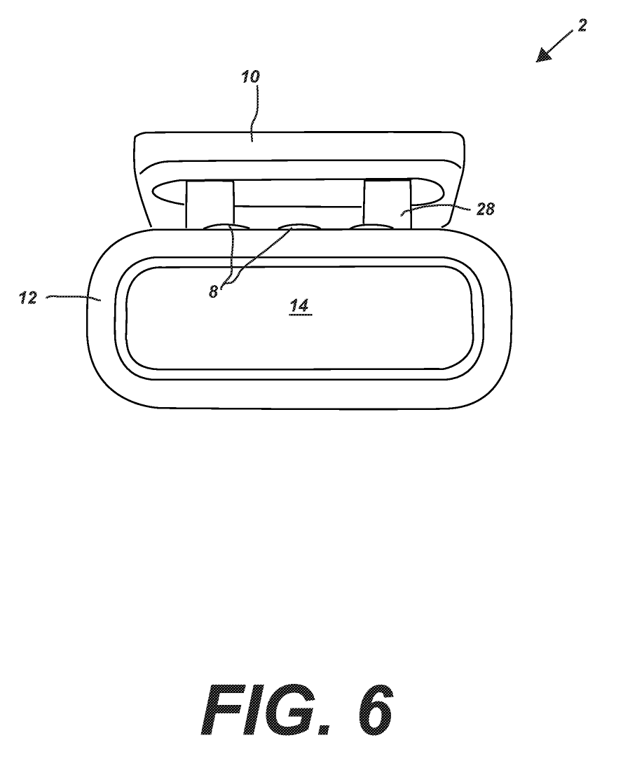

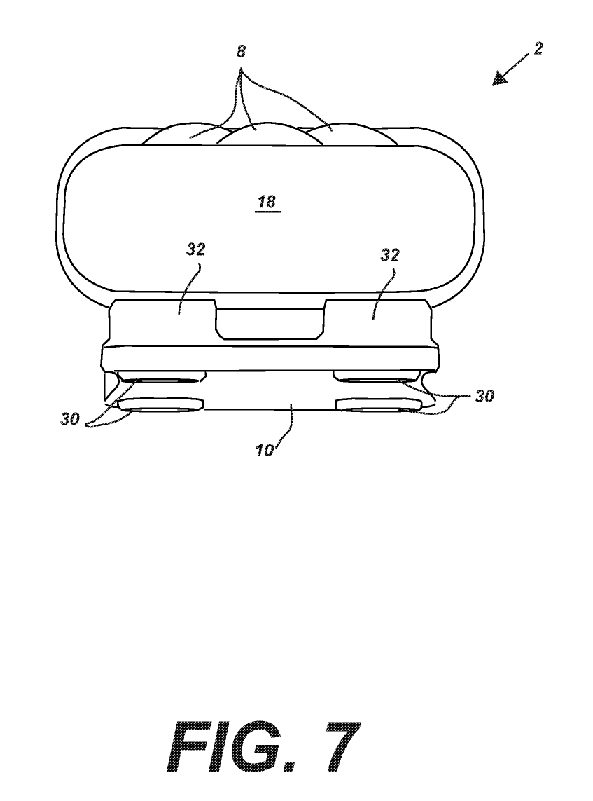

Referring to the figures, FIGS. 1-7 show a LED lamp 2 in an articulated position with its cap 18 removed, exposing the charging USB connector 16. The lamp 2 generally includes a base 4, an articulating head portion 6 including a light housing, and a pivot point 34 connecting the head portion to the base via a pin, hinge, or other connecting element. The light housing includes a several LEDs 8 and is part of the head portion. A switch 14 is located at the top 12 of the head portion 6. The switch is capable of turning on and off the LED lights 8. The top 12 of the head portion 6 may be manufactured from a grippable surface, such as rubber, for ease of articulating the head portion 6 about the pivot point 34. The switch 14 is contained within this portion.

A clip 10 is connected to the base 4 via a protrusion 28 in the base and a connecting pin 22 which allows the clip to hinge about the protrusion. A spring may also be included in the pin or about the pin to force the clip to clamp down against the base 4, thereby securing the base to another object, such as the bill of a cap or a shirt pocket. As shown, the clip 10 includes feet 30 which allow for gripping of the clip but also allow the lamp to be placed on a flat surface, clip-side down, and for the lamp to be balanced there. The fee 30 may also include magnets to allow the lamp 2 to be affixed to a metal surface. The clip also includes one or more clip teeth 32 at the end of the clip, which may contain grippable surfaces to better help the clip 10 secure the lamp 2 to an object.

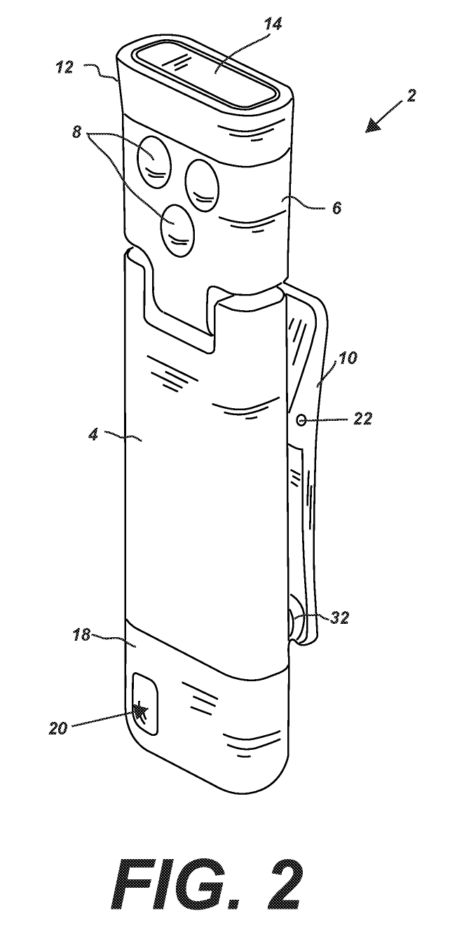

FIG. 2 shows the cap 18 securely connected to the base 4, thereby covering the USB connector 16. This connection requires the user to provide sufficient force to remove the cap 18 from the base 4, thereby preventing accidental removal of the cap. Because of this, a lanyard, cord, key chain, or other connector can be looped through the receiver slot 20 within the cap 18, allowing the entire lamp to be secured about the neck of the user (e.g. lanyard), or on a keychain or other suitable connection.

The lamp features at least three LED lights 8. The switch 14 cycles through lighting options. In a preferred embodiment there are at least three possible lighting options. With a first activation of the switch the LEDs will turn on in a single directional cone. This allows the lamp to be used as a flashlight to light up a scene of an accident or other location. The second activation of the switch turns the LEDs into a 360-degree illumination, functioning as a lantern to light up an area. The third activation of the switch will cause the LEDs to flash continuously. This allows the lamp to be used as a warning element to passing traffic while the user's vehicle is pulled over to the side of the road or for any other emergency situation. The fourth activation of the switch would turn all LEDs off. However, any combination of flashing or solid lights could be programmed into the switch 10 and delivered by the LEDs.

The lamp could alternatively, or preferably, be used as a general work light for indoor or outdoor jobs. For example, the light could be used for automobile repair work in a dimly lit garage or during the night.

Other examples of common use for the lamp would be as a lantern for camping or other outdoor activities. The lamp could be placed on a picnic table or outside of a tent for temporary, directional lighting. The lamp design suits it for carrying as a lantern.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A light emitting diode (LED) lamp comprising:
a base including a top end and a bottom end, said bottom end terminating into a universal serial bus (USB) connector;
an articulating head connected to said top end of said base via a hinged connection, whereby aid articulating head can be rotated at any angle between zero degrees and ninety degrees about said top end of said base;
said articulating head including a first face and a second face, wherein said first face comprises a first set of LEDs;
a switch configured to operate said first and second sets of LEDs, said switch located at a top end of said articulating head; and
a power source stored within said base and electrically connected to said LEDs through said hinged connection, said power source configured to receive additional power via said USB connector connected to an external power source.

2. The LED lamp of claim 1 further comprising:
said base including a protrusion;
a clip connected to said protrusion via a pin and spring connection; and
said clip configured to releasably connect said base to an external body.

3. The LED lamp of claim 2, further comprising:
said clip including a plurality of feet; and
wherein at least one of said plurality of feet includes a magnet configured for attaching to a metallic surface.

4. The LED lamp of claim 2, wherein said external body is an article of clothing;

5. The LED lamp of claim 4, wherein said article of clothing is the bill of a hat.

6. The LED lamp of claim 1, further comprising:
said second face of said articulating head comprises a second set of LEDs.

7. The LED flare of claim 6, wherein said switch is configured to activate said first set of LEDs only.

8. The LED flare of claim 6, wherein said switch is configured to activate said second set of LEDs only.

9. The LED flare of claim 6, wherein said switch is configured to activate both first and second sets of LEDs simultaneously.

10. The LED flare of claim 6, wherein said first set of LEDs are configured to flash on and off once activated.

11. The LED flare of claim 6, wherein said second set of LEDs are configured to flash on and off once activated.

12. The LED flare of claim 6, further comprising:
said switch configured to be pressed a first time to activate a first lighting configuration of said first set of LEDs;
said switch configured to be pressed a second time to activate a second lighting configuration of said first set of LEDs; and
said switch configured to be pressed a third time to deactivate said first set of LEDs.

13. The LED flare of claim 6, further comprising:
said switch configured to be pressed a first time to activate a first lighting configuration of said first and second sets of LEDs;
said switch configured to be pressed a second time to activate a second lighting configuration of said first and second sets of LEDs; and
said switch configured to be pressed a third time to deactivate said first and second sets of LEDs.
